(19) United States
(12) Patent Application Publication
(10) Pub. No.: US 2013/0135161 A1
(43) Pub. Date: May 30, 2013

(54) ANTENNA DEVICE

(71) Applicant: AISIN SEIKI KABUSHIKI KAISHA, Kariya-shi (JP)

(72) Inventors: Shingo FUJIMOTO, Tokai-shi (JP); Kiyokazu IEDA, Kariya-shi (JP)

(73) Assignee: AISIN SEIKI KABUSHIKI KAISHA, Kariya-shi (JP)

(21) Appl. No.: 13/664,972

(22) Filed: Oct. 31, 2012

(30) Foreign Application Priority Data
Nov. 1, 2011 (JP) 2011-240416

(51) Int. Cl. H01Q 21/28

(52) U.S. Cl. CPC H01Q 21/28
USPC 343/725

(57) ABSTRACT

An antenna device includes a first antenna including a first element formed in an annular form and having a length defined in accordance with a wavelength of a first frequency within a first frequency band, which is predetermined. The first antenna is configured to transmit and/or receive a signal of the first frequency. The first antenna also includes a retaining portion arranged at an outer peripheral portion of the first element and retains the first element in a state where a plane orthogonal to an axial direction of the first element conforms to a horizontal direction. The antenna device also includes a second antenna including a second element arranged at a radially inward position of the first element and configured to transmit and/or receive a signal of a second frequency within a second frequency band that is different from the first frequency band.

### CROSS REFERENCE TO RELATED APPLICATIONS

This application is based on and claims priority under 35 U.S.C. §119 to Japanese Patent Application 2011-240416, filed on Nov. 1, 2011, the entire content of which is incorporated herein by reference.

### TECHNICAL FIELD

This disclosure generally relates to an antenna device.

### BACKGROUND DISCUSSION

A vehicle of recent years is provided with a multiple number of antennas adapted for diversified on-vehicle telecommunication systems. The antennas are integrated and provided on the vehicle in consideration of installability and for providing a better look. Known integrated antennas are disclosed, for example, in JP2009-124577A, hereinafter referred to as Reference 1, and JP2005-260567A, hereinafter referred to as Reference 2.

An integrated antenna disclosed in Reference 1 includes equal to or more than two antennas. One of the antennas is disposed at a position offset from a center of a ground plane by a predetermined distance in a frontward direction or a rearward direction in a vehicle interior. One of other antennas is disposed at a position offset from the center of the ground plane by a predetermined distance in a direction opposite to the direction where the one of the antennas is disposed in the vehicle interior. An integrated antenna disclosed in Reference 2 includes a first antenna, a second antenna, and a ground plate. The ground plate is arranged such that at least a portion of the ground plate is inserted to the second antenna.

An antenna device disclosed in Reference 1 results in a size increase as a result of disposing two antennas separately in opposite directions relative to the center of the ground plane. The antenna device having a large size leads to a decrease in value in an aesthetic point of view. An antenna device disclosed in Reference 2 results in an increase in height of the integrated antenna as a whole as a result of the second antenna extending in a downward direction relative to the ground plate. In addition, an antenna performance of the antenna device disclosed in Reference 2 may decrease when the antenna device is installed, for example, on a vehicle body or on a portion having a flat plate form.

A need thus exists for an antenna device, which is not susceptible to the drawback mentioned above.

### SUMMARY

An antenna device includes a first antenna including a first element formed in an annular form and having a length defined in accordance with a wavelength of a first frequency within a first frequency band, which is predetermined. The first antenna is configured to transmit and/or receive a signal of the first frequency. The first antenna also includes a retaining portion arranged at an outer peripheral portion of the first element and retains the first element in a state where a plane orthogonal to an axial direction of the first element conforms to a horizontal direction. The antenna device also includes a second antenna including a second element arranged at a radially inward position of the first element and configured to transmit and/or receive a signal of a second frequency within a second frequency band that is different from the first frequency band.

### BRIEF DESCRIPTION OF THE DRAWINGS

The foregoing and additional features and characteristics of this disclosure will become more apparent from the following detailed description considered with the reference to the accompanying drawings, wherein:

FIG. 1A is a drawing illustrating a general description of a first frequency band and a second frequency band where an antenna device in this disclosure transmits and/or receives signals;

FIG. 1B is a drawing illustrating a general configuration of the antenna device disclosed in this disclosure;

FIG. 1C is a drawing illustrating a first element provided in the antenna device according to a first embodiment illustrated with a graph showing characteristics of a voltage standing wave ratio of the first antenna obtained by using the first element;

FIG. 1D is a drawing illustrating a second element provided in the antenna device according to the first embodiment illustrated with a graph showing characteristics of a voltage standing wave ratio of the second antenna obtained by using the second element;

FIG. 2A is a drawing illustrating a general configuration of the first antenna provided in the antenna device according to the first embodiment;

FIG. 2B is a drawing illustrating an electrical field distribution of the first antenna provided in the antenna device according to the first embodiment;

FIG. 3A is a drawing illustrating a general configuration of the second antenna provided in the antenna device according to the first embodiment;

FIG. 3B is a side view of the second antenna provided in the antenna device according to the first embodiment;

FIG. 4 is a drawing illustrating an example where the antenna device in this disclosure is installed on a vehicle;

FIG. 5 is a drawing illustrating an another embodiment of the first element provided in the antenna device in this disclosure;

FIG. 6A is a drawing illustrating the first antenna provided in the antenna device according to the first embodiment; and

FIG. 6B is a drawing illustrating another embodiment of the first antenna provided in the antenna device disclosed in this disclosure.

### DETAILED DESCRIPTION

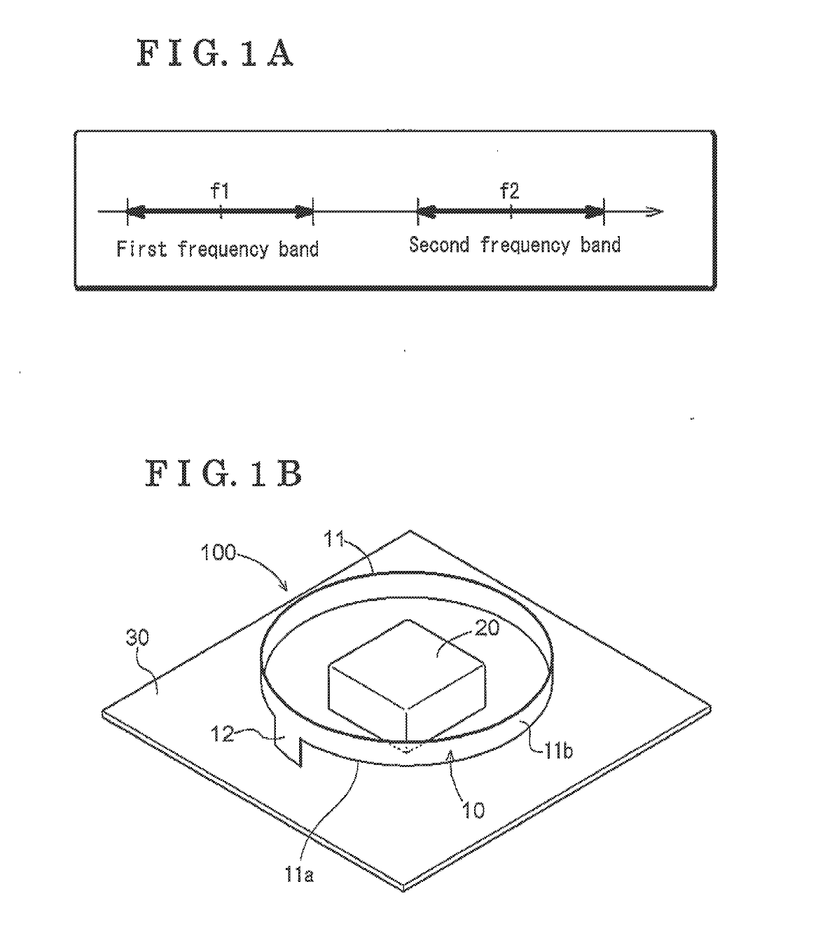

An antenna device 100 according to a first embodiment will be described in detail referring to drawings. A general concept of the antenna device 100 in this disclosure is illustrated in FIGS. 1A to 1D. The antenna device 100 is provided with functions to transmit and/or receive signals of multiple frequency bands. The antenna device 100 according to the first embodiment transmits and/or receives signals of a first frequency f1 within a first frequency band, which is predetermined, and a second frequency f2 within a second frequency band that is different from the first frequency band as shown in FIG. 1A. More specifically, the first frequency f1 is a frequency within 700 MHz band and the second frequency f2 is a frequency within 1.5 GHz band.

As FIG. 1B illustrates, the antenna device 100 includes a first antenna 10 and a second antenna 20. The first antenna 10 includes a first element 11 formed in an annular form as illustrated in FIG. 1C. The annular form of the first element 11 is provided with a circumference L1, or a peripheral length, defined in accordance with a wavelength of the first frequency f1. Accordingly, the first antenna 10 may be used for transmitting and/or receiving signals within the predetermined first frequency band including the first frequency f1.

The first frequency f1 is the frequency within 700 MHz band for the antenna device 100 according to the first embodiment. In a case where the frequency of the first frequency f1 is 700 MHz, the wavelength λ is approximately 43 centimeters (cm) long. Accordingly, the first element 11 is formed in the annular form provided with the circumference L1 of approximately 22 centimeters (cm), which is a length approximating λ/2. The first element L1 is capacitively coupled with a ground plane 30. Accordingly, the circumference L1 is shorter than the aforementioned value.

In FIG. 1C, a characteristic of a voltage standing wave ratio, which may be abbreviated as VSWR, of the first antenna 10 obtained by using the first element 11 is illustrated. A vertical axis in a graph in FIG. 1C represents the voltage standing wave ratio, or VSWR, and a horizontal axis represents a normalized value of the frequency calculated based on a formula f/f1. The graph in FIG. 1C indicates that the first antenna 10 is appropriate for transmitting and/or receiving the signals of the first frequency f1.

As FIG. 1D illustrates, the second antenna 20 includes a second element 21. The second element 21 is provided with a form having a length L2 defined in accordance with a wavelength of the second frequency f2 within the second frequency band, which is a frequency band different from the first frequency band. In FIG. 1D, the second element 21 is illustrated as a component having a square form provided with each side having the length L2, however, other appropriate forms may be allowed.

The second frequency f2 is a frequency within 1.5 GHz band for the antenna device 100 according to the first embodiment. In a case where the frequency of the second frequency f2 is 1.5 GHz, the wavelength λ is approximately 20 centimeters (cm) long. The length L2 is calculated based on a formula λ/4. Accordingly, the length L2 is made to approximately 5 centimeters (cm), which leads to forming the second element 21 in a compact size. The second element 21 is capacitively coupled with the ground plane 30 via a dielectric 24. As a result, the length L2 is shorter than the aforementioned value.

In FIG. 1D, a characteristic of a voltage standing wave ratio of the second antenna 20 obtained by using the second element 21 is illustrated. A vertical axis in the graph in FIG. 1D represents the voltage standing wave ratio, or VSWR, and a horizontal axis represents a normalized value of the frequency calculated based on a formula f/f2. The graph in FIG. 1D indicates that the second antenna 20 is appropriate for transmitting and/or receiving the signals of the second frequency f2.

The first antenna 10 includes the first element 11 provided with the circumference L1 as an electrical length and the second antenna 20 includes the second element 21 provided with the length L2 as the electrical length. Accordingly, the antenna device 100 may transmit and/or receive signals of two frequency bands based on L1 and L2.

The second antenna 20 is arranged at a position radially inward of the first element 11, which provides the antenna device 100 in a compact size. Arranging the height of the second antenna 20 to be lower than the top edge of the first element 11 restrains the height of the second antenna 20 from becoming high. Upon the arrangement described herewith, the height of the antenna device 100 may be provided with the height equals to or less than the height of the first element 11, which provides the antenna device 100 having a small height.

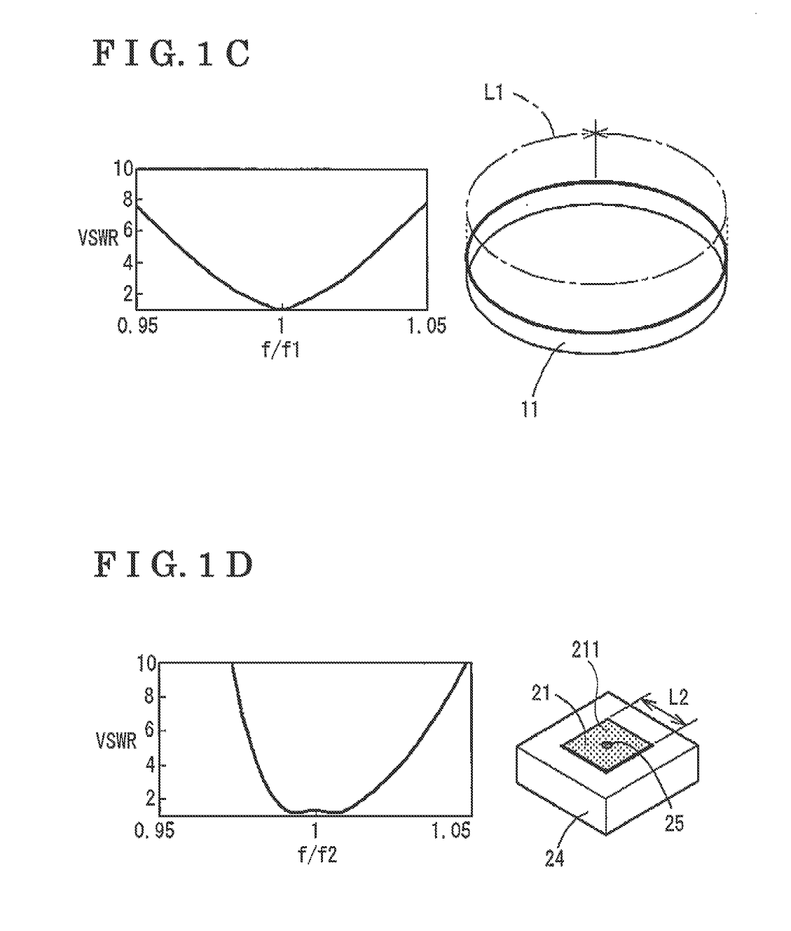

The configuration of the first antenna 10 will be described next. FIG. 2A is a drawing illustrating a general configuration of the first antenna 10. FIG. 2B is a drawing illustrating an electrical field distribution of the first element 11. As FIG. 2A illustrates, the first antenna 10 includes the first element 11 and the retaining portion 12. As described earlier, the first element 11 is a component formed in the annular form provided with the circumference L1 defined in accordance with the wavelength of the first frequency f1 within the predetermined first frequency band.

The antenna device 100 according to the first embodiment is provided with the first element 11 formed in a tubular form. The first element 11 formed in the tubular form is formed by rolling up a thin cupper plate or a similar conductive body having a length equal to the circumference L1 and then bonding the end portions in the circumferential direction by soldering or a similar method. The electrical length of the first element 11 accordingly formed in the tubular form is determined by the circumference L1 independently of a length in the axial direction. As a result, the length in the axial direction of the first element 11 may be shortened. Accordingly, the height of the first element 11 may be restrained to low, which in turn results in providing the first element 11 that is short in height. The electrical length of the first element 11 is determined by the outer perimeter of the tubular form. As a result, thickness of the aforementioned conductive body may be made to thin, which in turn results in providing the first element 11 that is light in weight and with decreased cost.

The first element 11 is fed with electricity via a wire 31. A cable core 13A of a coaxial cable 13, which transfers signals for transmitting or signals received, connects to the wire 31. An outer conductor 13B of the coaxial cable 13 connects to the ground plane 30. The ground plane 30 formed with a copper plate or a similar material is a grounding surface for the antenna device 100.

The retaining portion 12 that retains the first element 11 is provided at an outer peripheral portion 11a of the first element 11. The retaining portion 12 is grounded at the grounding plane 30. The outer peripheral portion 11a of the first element 11 is an edge portion in the axial direction at a radially outward end of the tubular form. The retaining portion 12 is formed with a conductive body similarly to the first element 11. The retaining portion 12 retains the first element 11 on the ground plane 30. As a result, the retaining portion 12 is formed with a material having a predetermined strength. The retaining portion 12 retains the first element 11 in a state such that a plane of the first element 11 orthogonal to the axial direction of the first element 11 conforms to, or aligns in, a horizontal direction. The plane orthogonal to the axial direction is a plane obtained in a state where the first element 11 formed in the tubular form is sliced in a direction that provides a cylindrical form. The retaining portion 12 retains the first element 11 in a state such that the plane of the first element 11 described herewith conforms to the horizontal direction.

In the antenna device 100 according to the first embodiment, the retaining portion 12 erects orthogonal to the ground plane 30. Accordingly, the portion of the first element 11 provided without the retaining portion 12 stays in a floating state relative to, or stays separated from, the ground plane 30. In addition, an outer peripheral surface 11b of the first element 11 extends parallel to the axial direction of the first element 11. Upon the arrangement described herewith, the first antenna 10 may transmit and/or receive the signals propagating along the radial direction of the first element 11.

FIG. 2B is a drawing illustrating the electrical field distribution of the first antenna 10. As FIG. 2B illustrates, the electrical field extends radially outward from the first element 11. The electrical field that extends radially inward of the first element 11 having opposite phases is balanced. As a result, the electrical field extending radially inward of the first element 11 is weaker relative to the electrical field extending radially outward of the first element 11. Furthermore, at a central portion of the radially inward of the first element 11, more specifically, at a position between a central axis C of the first element 11 and a portion on the first element 11 where the retaining portion 12 is provided, is in a state where substantially no electrical field is generated. The electrical field illustrated is divided into blocks according to predetermined field strengths in FIG. 2B similarly to expressing the height differences with contour lines, however, the actual electrical field extends seamlessly.

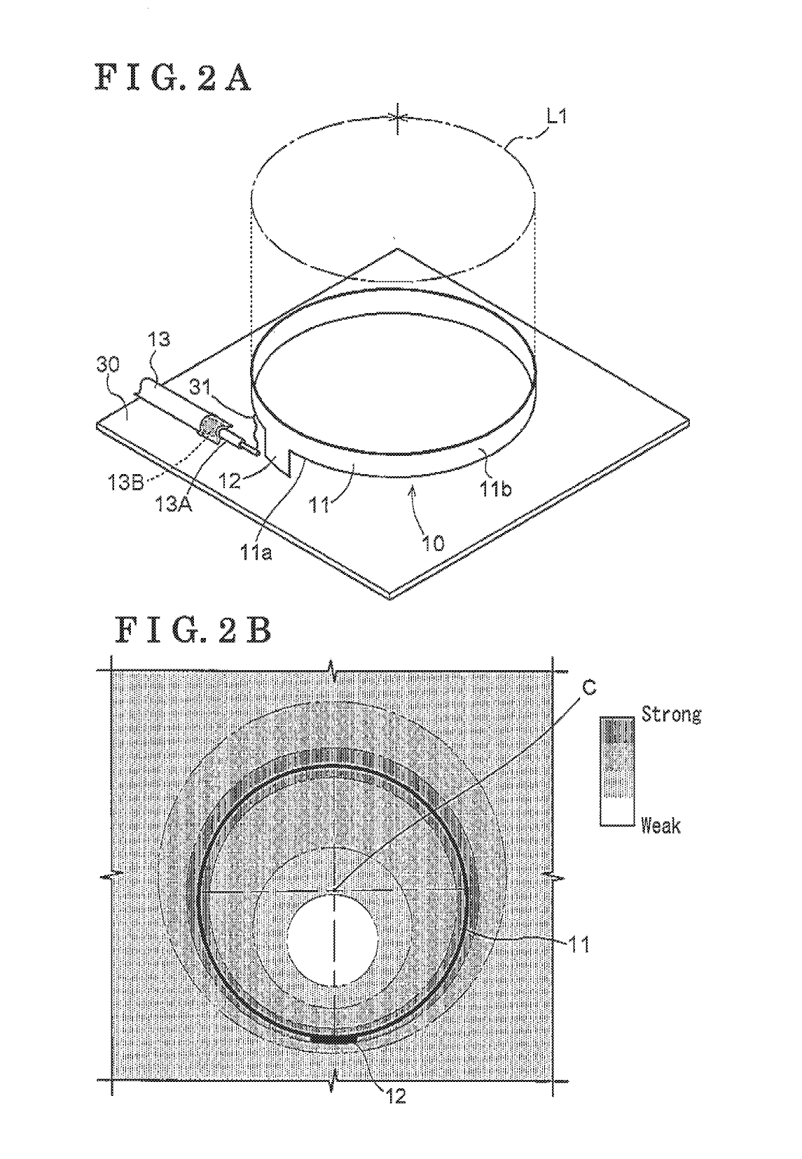

The configuration of the second antenna 20 will be described next. FIG. 3A is a drawing illustrating a general configuration of the second antenna 20. As FIG. 3A illustrates, the second antenna 20 provided in the antenna device 100 according to the first embodiment is formed in a quadrangular prism form. A cable 23 derives from the second antenna 20 for transferring the signals to be transmitted from the second element 21 or the signals received by the second element 21. The cable 23 is a coaxial cable.

FIG. 3B is a side view of the second antenna 20. The second element 21 is formed with an electrically conductive thin plate formed in a quadrilateral. At substantially center portion of the second element 21, an electricity feeding point 25 is provided. The second element 21 is arranged on an upper surface of a dielectric 24 formed in the quadrangular prism form. The cable 23 and the electricity feeding point 25 are connected through an inside of the dielectric 24, which is insulated. The cable 23 and the electricity feeding point 25 may be connected by providing the cable 23 outside of the dielectric 24 along an outside surface of the dielectric 24.

An electrical field distribution of the second element 21 is configured such that the electrical field extends stronger in a direction orthogonal to the second element 21. The second antenna 20 is arranged at a position radially inward of the first element 11. The second antenna 20 is arranged in a state where a radiation surface 211 is arranged parallel to the plane orthogonal to the axial direction of the first element 11. The radiation surface 211 is an outward surface of the second element 21 having the quadrilateral form. The first element 11 is arranged so that the plane orthogonal to the axial direction of the first element 11 conforms to the horizontal direction. Accordingly, the second element 21 is arranged so that the second element 21 conforms to the horizontal direction. Upon the arrangement described herewith, the second antenna 20 may transmit and/or receive signals propagating along the axial direction of the first element 11.

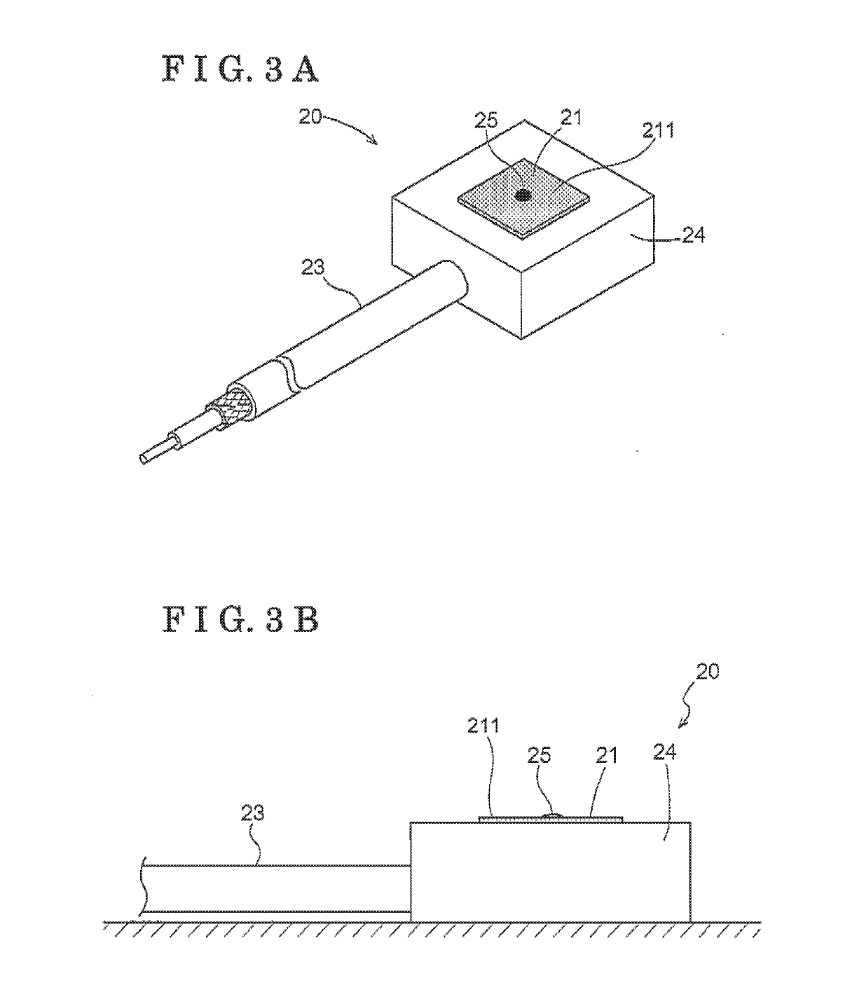

FIG. 4 is a drawing illustrating an example where the antenna device 100 disclosed in this disclosure is installed on a vehicle 50. Arranging the antenna device 100 on a dashboard in a vehicle interior as FIG. 4 illustrates is an example of an effective arrangement of the antenna device 100. Signals from a vehicle-to-vehicle communication system or a roadside-to-vehicle communication system propagate in a frontward and rearward direction and a left and right direction relative to the vehicle 50. Navigation signals from a navigation satellite propagate from an upward direction relative to the vehicle 50. Accordingly, arranging the electrical length of the first element 11 to correspond with a frequency of at least one of the vehicle-to-vehicle communication system and the roadside-to-vehicle communication system and arranging the electrical length of the second element 21 to correspond with a frequency for communicating with the navigation satellite are considered as effective arrangements. Upon the arrangement described herewith, the first antenna 10 may transmit and/or receive signals of at least one of the vehicle-to-vehicle communication system and the roadside-to-vehicle communication system and the second antenna 20 may receive the navigational signals from the navigation satellite.

As described earlier, the electrical field strength at radially inward of the first element 11 of the antenna device 100 disclosed in this disclosure is weak. Accordingly, an effect of the first element 11 on the second antenna 20 arranged at a position radially inward of the first element 11 may be reduced. In other words, the first antenna 10 and the second antenna 20 are reliably isolated from each other, so that the antenna device 100 as an integrated antenna device may transmit and/or receive signals of the first frequency band and of the second frequency band with high sensitivity. The position radially inward of the first element 11 where the second antenna 20 is arranged is an unused vacant space. Accordingly, a size of the antenna device 100 may be provided with the size of the first antenna 10. As a result, the antenna device 100 may be provided with a compact size and without an excessive height, which in other words is short in height.

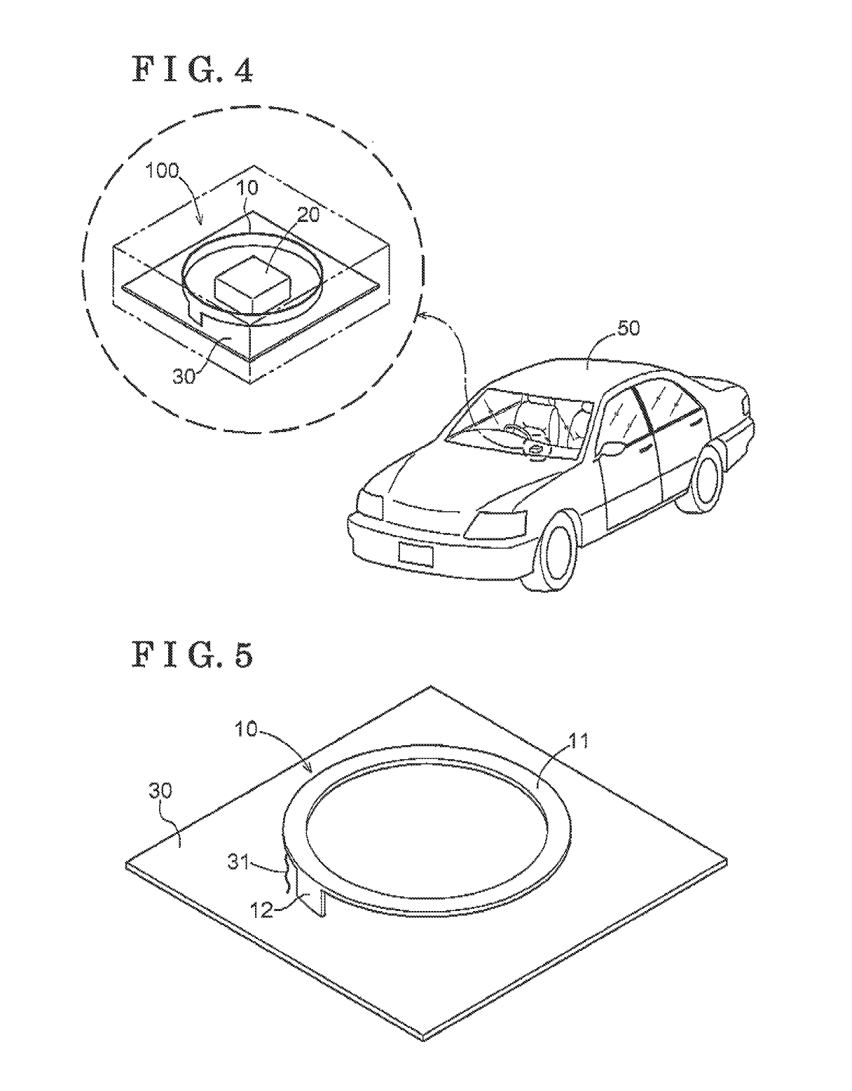

The antenna device 100 according to other embodiments are described next. The first element 11 of the antenna device 100 according to the first embodiment is formed in the tubular form as described earlier. Nevertheless, the form of the first element 11 is not limited to the form described herewith. The first element 11 may be formed in an annular plate form instead of the tubular form as FIG. 5 illustrates. The first element 11 provided with the annular plate form provides the electrical field distribution at radially outward of the first element 11 similarly to the first element 11 provided in the first embodiment and may transmit and/or receive the signals propagating along the radial direction of the first element 11. Upon the arrangement described herewith, the electrical field at radially inward of the first element 11 is weak, so that the second antenna 20 may be arranged at a position radially inward of the first element 11.

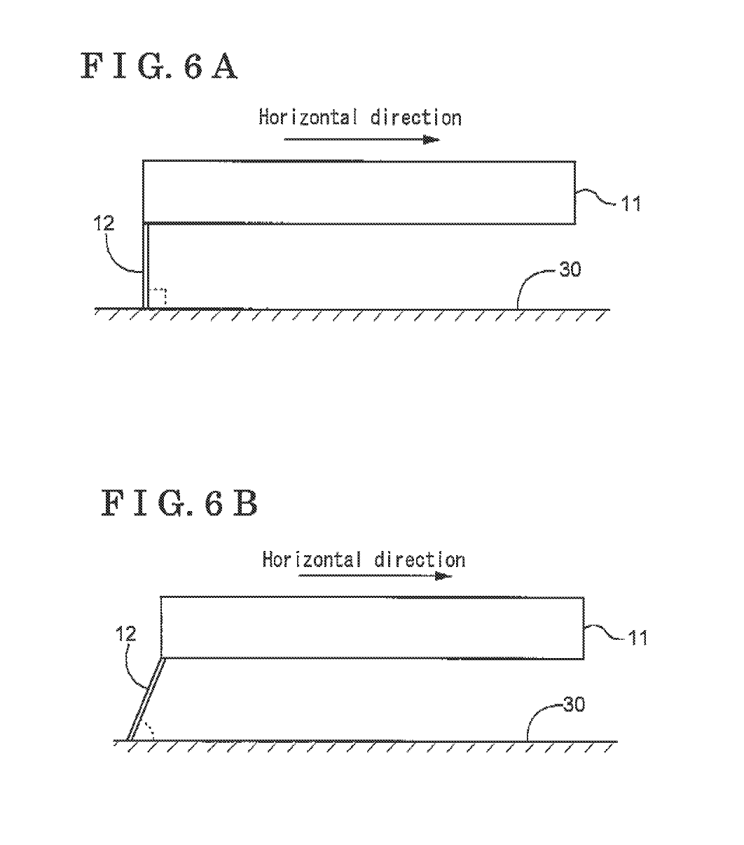

In the antenna device 100 according to the first embodiment, the retaining portion 12 erects orthogonal to the ground plane 30 as FIG. 6A illustrates. Nevertheless, the arrangement of the retaining portion 12 is not limited to the arrangement described herewith. As FIG. 6B illustrates the retaining portion 12 may or may not erect orthogonal to the ground plane 30 provided that the retaining portion 12 retains the first element 11 in a state such that the radial direction of the first element 11 conforms to the horizontal direction.

In the antenna device 100 according to the first embodiment, the first frequency f1 is defined as the frequency within 700 MHz band and the second frequency f2 is defined as the frequency within 1.5 GHz band. Nevertheless, the frequencies that apply to the antenna device 100 are not limited to the frequencies of the aforementioned frequency bands. The frequency f1 and the frequency f2 may be frequencies within other frequency bands. In a case where the frequency used for the vehicle-to-vehicle communication system or the roadside-to-vehicle communication system is changed, the circumference L1 of the first element 11 may be appropriately altered according to the changed frequency. Furthermore, the frequency of the first frequency f1 may be higher than the frequency of the second frequency f2.

In the antenna device 100 according to the first embodiment, the height of the second antenna 20 is provided at the height where the second antenna 20 does not protrude above the top edge of the first element 11. Nevertheless, the height of the second antenna 20 is not limited to the height as described earlier. The second antenna 20 may have the height such that the second antenna 20 protrudes above the top edge of the first element 11.

In the antenna device 100 according to the first embodiment, each of the first antenna 10 and the second antenna 20 are configured to transmit and/or receive the signals of the first frequency band and the signals of the second frequency band, respectively. Antennas that transmit and/or receive the signals, in other words, provide at least one of a function to transmit the signals and a function to receive the signals. Nevertheless, each of the first antenna 10 and the second antenna 20 may be provided with a single function either to transmit or to receive the signals. Each of the antennas may be provided with each function to transmit and to receive the signals. The first antenna 10 and the second antenna 20 may be provided with different functionalities relative to each other in regards to transmitting and receiving signals.

In the antenna device 100 according to the first embodiment, the first element 11 is provided in a condition such that the first element 11 is surrounded by air. Nevertheless, the first element 11 may be provided in a condition where the first element 11 is filled with resin or similar material, which is effective in shortening the wavelength. Upon the arrangement described herewith, the first element 11 may be reduced in size.

In the antenna device 100 described in the first embodiment, the first element 11 and the coaxial cable 13 are connected via the wire 31. Nevertheless, the method of connection is not limited to the arrangement described herewith. The first element 11 and the cable core 13A of the coaxial cable 13 may be directly connected.

The antenna device 100 according to this disclosure may be applied for providing an antenna device that transmits and/or receives signals from a multiple number of frequency bands.

According to an aspect of this disclosure, the antenna device 100 includes the first antenna 10 including the first element 11 formed in the annular form and having the length defined in accordance with the wavelength of the first frequency f1 within the first frequency band, which is predetermined. The first antenna 10 is configured to transmit and/or receive the signal of the first frequency f1. The first antenna 10 also includes the retaining portion 12 arranged at the outer peripheral portion 11a of the first element 11 and retains the first element 11 in the state where the plane orthogonal to the axial direction of the first element 11 conforms to the horizontal direction. The antenna device 100 also includes the second antenna 20 including the second element 21 arranged at the radially inward position of the first element 11 and configured to transmit and/or receive the signal of the second frequency f2 within the second frequency band that is different from the first frequency band.

The electrical field strength at radially inward of the first element 11 is weak. As a result, by arranging the second element 21 at the radially inward position of the first element 11, the effect of the first element 11 on the second element 21 is reduced. Accordingly, the first antenna 10 and the second antenna 20 are reliably isolated from each other, so that the antenna device 100 as an integrated antenna device may transmit and/or receive signals of the first frequency band and of the second frequency band with high sensitivity. The position radially inward of the first element 11 where the second antenna 20 is arranged is an unused vacant space. Accordingly, the size of the antenna device 100 may be provided with the size of the first antenna 10. As a result, the antenna device 100 may be provided with the compact size and without the excessive height.

According to another aspect of this disclosure, the first element 11 of the antenna device 100 includes the outer peripheral surface 11b extending parallel to the axial direction of the first element 11.

Upon the arrangement described herewith, the first antenna 10 may transmit and/or receive the signals propagating along the radial direction of the first element 11, which in other words signals propagating in the horizontal direction.

According to further aspect of this disclosure, the second element 21 of the antenna device 100 includes the radiation surface 211 that transmits and/or receives the signal of the second frequency f2 arranged parallel to the plane orthogonal to the axial direction of the first element 11.

Upon the arrangement described herewith, the second antenna 20 may transmit and/or receive signals propagating along the axial direction of the first element 11, which in other words is signals propagating from the upward direction of the antenna device 100.

According to another aspect of this disclosure, the first element 11 of the antenna device 100 is formed in the tubular form.

Accordingly, the first element 11 may be formed without difficulties by rolling up a strip of conductive body. By providing the first element 11 with a simple structure, manufacturing cost of the antenna device 100 is reduced. Forming the first element 11 in the tubular form results in enhancing the mechanical strength of the device.

According to further aspect of this disclosure, the antenna device 100 further includes the ground plane 30, and the retaining portion 12 erects orthogonally relative to the ground plane 30.

Upon the arrangement described herewith, the ground plane 30 and the first element 11 are connected with a shortest distance, which is effective in reducing cost of materials.

According to another aspect of this disclosure, the signal of the first frequency f1 of the antenna device 100 includes at least one of signals from the vehicle-to-vehicle communication system and the roadside-to-vehicle communication system and the signal of the second frequency f2 includes the navigation signal from the navigation satellite.

Upon the arrangement described herewith, the antenna device 100 receiving at least one of the signals from the vehicle-to-vehicle communication system and the roadside-to-vehicle communication system and the navigation signal from the navigation satellite is provided with a compact size, which in turn increases flexibility on installing the antenna device 100.

According to further aspect of this disclosure, the second element 21 of the antenna device 100 is arranged at the position between the central axis C of the first element 11 and the portion on the first element 11 where the retaining portion 12 is provided.

The electrical field strength is weak at the position between the central axis C of the first element 11 and the portion where the retaining portion 12 of the first element is provided relative to other portions. Accordingly, the signals the second element 21 transmit and/or receive is less susceptible to the electrical field, so that the second element 21 transmits and/or receives signals with appropriately fine sensitivity.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. An antenna device, comprising:
a first antenna including a first element formed in an annular form and having a length defined in accordance with a wavelength of a first frequency within a first frequency band, which is predetermined, the first antenna being configured to transmit and/or receive a signal of the first frequency;
the first antenna including a retaining portion arranged at an outer peripheral portion of the first element and retaining the first element in a state where a plane orthogonal to an axial direction of the first element conforms to a horizontal direction; and
a second antenna including a second element arranged at a radially inward position of the first element and configured to transmit and/or receive a signal of a second frequency within a second frequency band that is different from the first frequency band.

2. The antenna device according to claim 1, wherein the first element includes an outer peripheral surface extending parallel to the axial direction of the first element.

3. The antenna device according to claim 1, wherein the second element includes a radiation surface that transmits and/or receives the signal of the second frequency arranged parallel to the plane orthogonal to the axial direction of the first element.

4. The antenna device according to claim 1, wherein the first element is formed in a tubular form.

5. The antenna device according to claim 1, further comprising:
a ground plane, wherein the retaining portion erects orthogonally relative to the ground plane.

6. The antenna device according to claim 1, wherein the signal of the first frequency includes at least one of signals from a vehicle-to-vehicle communication system and a roadside-to-vehicle communication system and the signal of the second frequency includes a navigation signal from a navigation satellite.

7. The antenna device according to claim 1, wherein the second element is arranged at a position between a central axis of the first element and a portion on the first element where the retaining portion is provided.
